(19) United States
(12) Patent Application Publication
(10) Pub. No.: US 2003/0149693 A1
(43) Pub. Date: Aug. 7, 2003

(54) Look-ahead locating of communication numbers

(76) Inventor: Steve R. Dobler, Stanhope, NJ (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/072,184

(22) Filed: Feb. 7, 2002

(51) Int. Cl. G06F 7/00

(52) U.S. Cl. 707/6

(57) ABSTRACT

A method of locating a communication number prior to receiving an entire communication number being entered. One or more digits of a candidate communication number are received. A database is searched for a communication number corresponding to the one or more digits of the candidate communication number. A communication number corresponding to the one or more digits of the candidate communication number is located within the database. The located communication number corresponding to the one or more digits of the candidate communication number is transmitted to a presenting location prior to receiving the entire candidate communication number.

### FIELD OF THE INVENTION

The present invention relates to locating data. More particularly, the invention relates to locating a communication number prior to receiving an entire communication number being entered.

### BACKGROUND

In a telephony system, a telephone user dials a telephone number in order to establish a connection with the telephone associated with the telephone number dialed. Telephone numbers typically consist of seven or more digits. Speed dialing is a feature that allows the user to dial a telephone number more quickly.

Generally, with speed dialing a user presses one button or two buttons on a telephone, and the telephone automatically dials a telephone number assigned to the button(s) pressed. Consequently, the user presses only the one or two buttons assigned to the telephone number, rather than the seven or more buttons corresponding to the digits of the telephone number. Speed dialing is available within a telephony system or as part of a stand-alone telephone.

With speed dialing, the user builds a database of telephone numbers accessed by speed dialing. The user enters one or more telephone numbers individually and assigns one or two speed dial buttons to each telephone number entered. The entered telephone number is stored and linked with the speed dial button(s) assigned to it. The user labels the speed dial button(s) or otherwise provides a way to determine the particular telephone number associated with the speed dial button(s).

Entering telephone numbers, assigning a speed dial button(s) to each telephone number entered and labeling the speed dial buttons (or otherwise associating the speed dial button with the telephone number to which it is assigned) is time consuming. In addition, the number of telephone numbers that can be entered and stored is limited because there is a limited number of buttons to which to assign telephone numbers.

### BRIEF DESCRIPTION OF THE DRAWINGS

The invention is illustrated by way of example, and not by way of limitation, in the figures of the accompanying drawings in which like reference numerals refer to similar elements.

FIG. 1 is a block diagram of one embodiment of an electronic system.

FIG. 2 is a flow diagram of one embodiment of locating a communication number prior to receiving an entire communication number being entered.

FIG. 3 is a block diagram of one embodiment of locating a communication number prior to receiving an entire communication number being entered.

### DETAILED DESCRIPTION

A method of locating a communication number prior to receiving an entire communication number being entered is described. In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

A method of locating a communication number prior to receiving an entire communication number being entered is described. One or more digits of a candidate communication number, e.g., a telephone number, are received. A database is searched for a communication number corresponding to the one or more digits received. A communication number corresponding to the one or more digits received is located. The located communication number is transmitted to a presenting location, e.g., a telephone display screen. If the located communication number being presented is selected, the communication number is used to attempt to establish a connection with the device associated with the selected communication number.

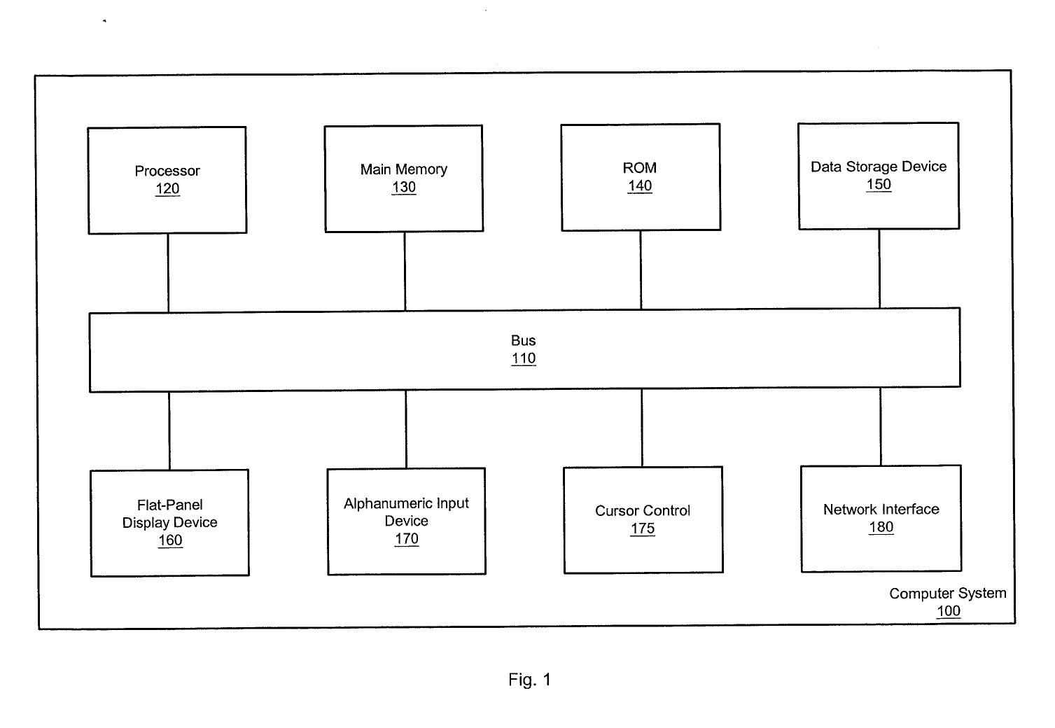

FIG. 1 is a block diagram of one embodiment of an electronic system. In one embodiment, the method described herein can be implemented as sequences of instructions executed by an electronic system. The sequences of instructions can be stored by the electronic system. In addition, the instructions can be received by the electronic system (e.g., via a network connection). The electronic system is intended to represent a range of electronic systems, wired or wireless, including, for example, a personal computer, a personal digital assistant (PDA), a laptop or palmtop computer, a cellular phone, a network access device, etc. Other electronic systems can include more, fewer and/or different components.

Electronic system 100 includes a bus 110 or other communication device to communicate information, and processor 120 coupled to bus 110 to process information. While electronic system 100 is illustrated with a single processor, electronic system 100 can include multiple processors and/or co-processors.

Electronic system 100 further includes random access memory (RAM) or other dynamic storage device 130 (referred to as memory), coupled to bus 110 to store information and instructions to be executed by processor 120. Memory 130 also can be used to store temporary variables or other intermediate information while processor 120 is executing instructions. Electronic system 100 also includes read-only memory (ROM) and/or other static storage device 140 coupled to bus 110 to store static information and instructions for processor 120. In addition, data storage device 150 is coupled to bus 110 to store information and instructions. Data storage device 150 may comprise a magnetic disk (e.g., a hard disk) or optical disc (e.g., a CD-ROM) and corresponding drive.

Electronic system 100 may further comprise a flat-panel display device 160, such as a cathode ray tube (CRT) or liquid crystal display (LCD), to display information to a user. Alphanumeric input device 170, including alphanumeric and other keys, is typically coupled to bus 110 to communicate information and command selections to processor 120. Another type of user input device is cursor control 175, such as a mouse, a trackball, or cursor direction keys to communicate direction information and command selections to processor 120 and to control cursor movement on flat-panel display device 160. Electronic system 100 further includes network interface 180 to provide access to a network, such as a local area network.

Instructions are provided to memory from a machine-accessible medium, or an external storage device accessible via a remote connection (e.g., over a network via network interface 180) providing access to one or more electronically-accessible media, etc. A machine-accessible medium includes any mechanism that provides (i.e., stores and/or transmits) information in a form readable by a machine (e.g., a computer). For example, a machine-accessible medium includes RAM; ROM; magnetic or optical storage medium; flash memory devices; electrical, optical, acoustical or other form of propagated signals (e.g., carrier waves, infrared signals, digital signals); etc.

In alternative embodiments, hard-wired circuitry can be used in place of or in combination with software instructions to implement the present invention. Thus, the present invention is not limited to any specific combination of hardware circuitry and software instructions.

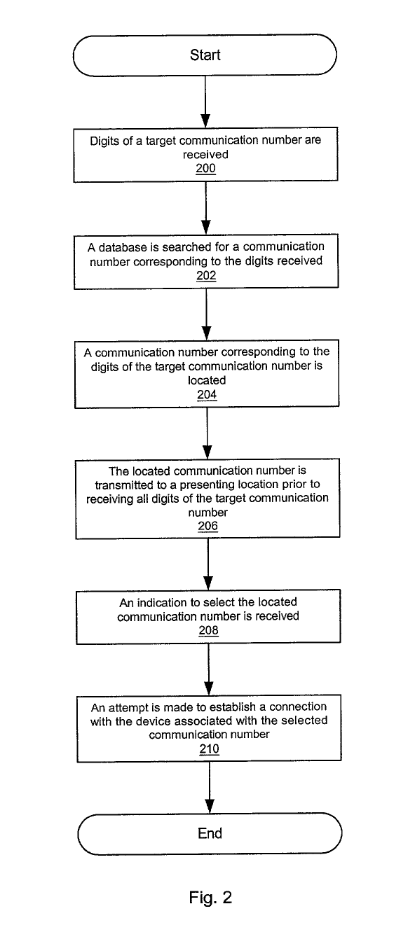

FIG. 2 is a flow diagram of one embodiment of locating a communication number prior to receiving an entire communication number being entered. At 200, one or more digits of a candidate communication number are received. For example, the digits 1 and 2 of the candidate communication number “123-4567” are received. A communication number is a number assigned to a device, e.g., a wired telephone, a cellular telephone, a PDA, a modem, a facsimile machine, etc., that is used to establish a connection with the device. A candidate communication number is a communication number being entered in order to establish a connection with a device or determine the communication number used to establish a connection with a device.

In one embodiment, the one or more digits of the candidate communication number are the digits of a telephone number received from a telephone or an electronic system as the digits of the telephone number are entered. However, the communication number can be other than a telephone number, e.g., a number for establishing a connection with a modem, a facsimile machine or an electronic system.

At 202, a database is searched for a communication number corresponding to the one or more digits received. For example, after receiving the digits 1 and 2 of the communication number “123-4567,” a database is searched for communication numbers containing the digits 1 and 2. In one embodiment, the database is located in a telephony system. However, the database can be located in another location, e.g., in a telephone or in a computer network. In one embodiment, the database contains communication numbers previously entered, e.g., telephone numbers previously dialed from a telephone. However, the database can contain other communication numbers, e.g., communication numbers of devices attempting to establish a connection with a communication device, communication numbers entered into the database via a keypad or a voice-activated input device, or communication numbers loaded into the database from a data storage device, a computer network or a telephony network. Storing data from various sources in a database is well-known to those of ordinary skill in the art, and thus will not be discussed further except as it applies to the present technique.

In one embodiment, the database is searched after each digit is received. However, the database can be searched after a group of digits is received, e.g., after the first three, and after receiving each successive digit following the group. In one embodiment, the search is conducted by comparing the digits received to the digits of the communication numbers in the database. However, other searching techniques can be used. In one embodiment, the search for the communication number is based on locating a communication number containing digits whose sequence corresponds to the order in which the digits of the candidate communication number are received. However, the search can be conducted based whether a communication number contains the digits received, without regard to a correlation between the sequences of the digits in the communication number and the digits received. Searching a database for data is wellknown to those of ordinary skill in the art, and thus will not be discussed further except as it pertains to the present technique.

At 204, a communication number corresponding to the one or more digits of the candidate communication number is located in the database. For example, after receiving the digits 1 and 2 of the communication number “123-4567,” the communication number “123-4567” is located in the database. At 206, the located communication number corresponding to the one or more digits of the candidate communication number is transmitted to a presenting location prior to receiving all digits of the candidate communication number. For example, the located communication number “123-4567” is transmitted from the database to a telephone containing a display screen.

In one embodiment, one located communication number corresponding to the one or more digits of the candidate communication number is transmitted to a presenting location prior to receiving all digits of the candidate communication number. In an alternative embodiment, a plurality of located communication numbers corresponding to the one or more digits of the candidate communication number is transmitted to the presenting location prior to receiving all digits of the candidate communication number. However, the number of the plurality of located communication numbers is reduced as located communication numbers fail to contain each subsequently received digit of the candidate communication number.

In one embodiment, the presenting location is the telephone, which contains a display screen, from which the one or more digits of a candidate telephone number are received. However, the presenting location can be a different location, e.g., an electronic system data display location (for example, a CRT or an LCD) or a memory location in an electronic system.

At 208, an indication to select the located communication number is received. For example, a button is pushed to select the located communication number “123-4567” being displayed on a telephone display screen. In one embodiment, the indication to select the located communication number is received as a result of the pressing of a button on a telephone displaying a located telephone number. However, the indication to select the located communication number can be received in a different manner, e.g., by selecting in an electronic system a memory location containing the located telephone number, or using a cursor control to select a located telephone number displayed on an electronic system data display location.

At 210, an attempt is made to establish a connection with the device associated with a selected communication number. For example, once the located communication number “123-4567” is selected, the telephone displaying the located communication number “123-4567” dials the communication number “123-4567.” In one embodiment, the selected communication number is automatically dialed by a telephone displaying a located telephone number that is selected. However, the attempt to establish a connection can occur in another manner, e.g., as a result of automatic dialing by an electronic system containing the selected communication number, or by a person manually dialing the selected communication number.

Although the method described herein is not limited to use with a telephone, the technique described herein provides the benefits of speed dialing without the limitations of the speed dialing technology. Storing telephone numbers in a database allows more telephone numbers to be stored than when buttons on a telephone are assigned to telephone numbers that are to be accessed by speed dialing. Gathering telephone numbers called from a telephone and/or telephone numbers of devices attempting to establish a connection with the telephone eliminates having to enter telephone numbers and assign speed dial buttons to the telephone numbers entered. Automatically dialing a selected telephone number corresponding to the digits of a candidate telephone number, where the selected telephone number was displayed prior to receiving the entire candidate telephone number, eliminates having to associate a speed dial button with its assigned telephone number.

FIG. 2 describes retrieval of a communication number in terms of a method. However, one should also understand it to represent a machine-accessible medium having recorded, encoded or otherwise represented thereon instructions, routines, operations, control codes, or the like, that when executed by or otherwise utilized by an electronic system, cause the electronic system to perform the method as described above or other embodiments thereof that are within the scope of this disclosure.

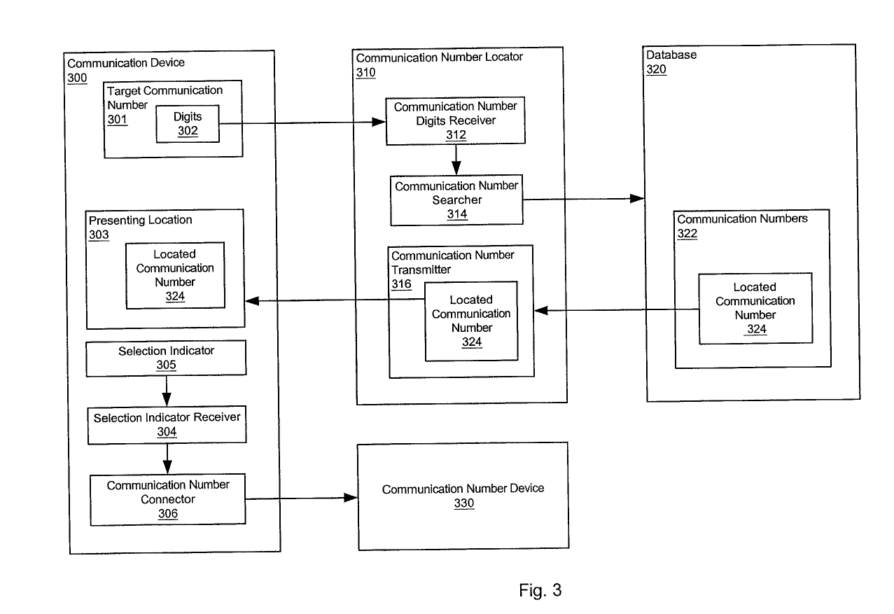

FIG. 3 is a block diagram of one embodiment of locating a communication number prior to receiving an entire communication number being entered. Communication number digits receiver 312 of communication number locator 310 receives from communication device 300 digits 302 of candidate communication number 301. Communication number searcher 314 searches database 320, which contains communication numbers 322, for a communication number corresponding to digits 302.

Communication number searcher 314 locates located communication number 324, which is transmitted to communication number transmitter 316. Communication number transmitter 316 transmits located communication number 324 to presenting location 303 prior to communication number digits receiver 312 receiving all digits 302. Presenting location 303 presents located communication number 324. When selection indicator receiver 304 receives selection indicator 305 to select located communication number 324, communication number connector 306 attempts to use communication number 324 to establish a connection between communication device 300 and communication number device 330.

In the foregoing specification, the invention has been described with reference to specific embodiments thereof. It will, however, be evident that various modifications and changes can be made thereto without departing from the broader spirit and scope of the invention. The specification and drawings are, accordingly, to be regarded in an illustrative rather than a restrictive sense.

What is claimed is:

1. A method comprising:
receiving one or more digits of a candidate communication number;
searching a database for a communication number corresponding to the one or more digits of the candidate communication number;
locating within the database a communication number corresponding to the one or more digits of the candidate communication number; and
transmitting a located communication number to a presenting location prior to receiving an entire candidate communication number.

2. The method of claim 1, wherein the communication number comprises a telephone number.

3. The method of claim 2, wherein the database contains one or more telephone numbers previously dialed from a telephone.

4. The method of claim 2, wherein the database contains one or more telephone numbers of one or more devices previously attempting to establish a connection with a telephone.

5. The method of claim 1, wherein the database is located in a telephony system.

6. The method of claim 1, wherein the database is located in the telephone.

7. The method of claim 1, wherein the presenting location comprises the telephone.

8. The method of claim 1, wherein the presenting location comprises a data display location of the electronic system.

9. The method of claim 1, wherein the database is located in a computer network.

10. The method of claim 1, wherein searching the database for the communication number corresponding to the one or more digits of the candidate communication number comprises searching the database after receiving each digit following a group of the one or more digits of the candidate communication number.

11. The method of claim 1, wherein transmitting the located communication number to the presenting location prior to receiving the entire candidate communication number comprises:
transmitting one or more located communication numbers corresponding to the one or more digits of the candidate communication number from the database to the presenting location prior to receiving the entire candidate communication number; and
reducing the one or more located communication numbers, as the one or more located communication numbers fail to contain each subsequently received digit of the candidate communication number.

12. A method comprising:
receiving from a digit inputter of a telephone a partial telephone number having one or more digits corresponding to a candidate communication number;
searching a database for a telephone number corresponding to the partial telephone number;
locating in the database one or more telephone numbers corresponding to the partial telephone number; and
returning to a display screen of the telephone one or more located telephone numbers, prior to receiving an entire candidate telephone number.

13. The method of claim 12, wherein the digit inputter comprises a telephone keypad.

14. The method of claim 12, wherein the digit inputter comprises a voiceactivated dialing mechanism.

15. The method of claim 12, wherein the database is located in the telephone.

16. The method of claim 12, wherein the database is located in a telephony system.

17. The method of claim 12, wherein the database contains one or more telephone numbers previously dialed from the telephone.

18. The method of claim 12, wherein the database contains one or more telephone numbers of one or more incoming telephone calls to the telephone.

19. The method of claim 12, further comprising:
receiving a selection indication to select a located telephone number appearing on the display screen of the telephone; and
dialing, as a result of receiving the selection indication, a selected located telephone number appearing on the display screen of the telephone.

20. An article of manufacture comprising:
a machine-accessible medium including thereon sequences of instructions that, when executed, cause an electronic system to:
receive one or more digits of a candidate communication number;
search a database for a communication number corresponding to the one or more digits of the candidate communication number;
locate within the database a communication number corresponding to the one or more digits of the candidate communication number; and
transmit a located communication number to a presenting location prior to receiving an entire candidate communication number.

21. The article of manufacture of claim 20, wherein the sequences of instructions that, when executed, cause the electronic system to receive one or more digits of the candidate communication number comprise sequences of instructions that, when executed, cause the electronic system to receive the one or more digits of a candidate telephone number.

22. The article of manufacture of claim 21, wherein the sequences of instructions that, when executed, cause the electronic system to search the database for the communication number corresponding to the one or more digits of the candidate communication number comprise sequences of instructions that, when executed, cause the electronic system to search a database containing one or more telephone numbers previously dialed from a telephone for the communication number corresponding to the one or more digits of the candidate communication number.

23. The article of manufacture of claim 21, wherein the sequences of instructions that, when executed, cause the electronic system to search the database for the communication number corresponding to the one or more digits of the candidate communication number comprise sequences of instructions that, when executed, cause the electronic system to search a database containing one or more telephone numbers of one or more devices previously attempting to establish a connection with a telephone for the communication number corresponding to the one or more digits of the candidate communication number.

24. The article of manufacture of claim 20, wherein the sequences of instructions that, when executed, cause the electronic system to search the database for the communication number corresponding to the one or more digits of the candidate communication number comprise sequences of instructions that, when executed, cause the electronic system to search a database located in a telephony system for the communication number corresponding to the one or more digits of the candidate communication number.

25. The article of manufacture of claim 20, wherein the sequences of instructions that, when executed, cause the electronic system to search the database for the communication number corresponding to the one or more digits of the candidate communication number comprise sequences of instructions that, when executed, cause the electronic system to search a database located in the telephone for the communication number corresponding to the one or more digits of the candidate communication number.

26. The article of manufacture of claim 20, wherein the sequences of instructions that, when executed, cause the electronic system to transmit the located communication number to the presenting location prior to receiving the entire candidate communication number comprise sequences of instructions that, when executed, cause the electronic system to transmit the located communication number to a telephone prior to receiving the entire candidate communication number.

27. The article of manufacture of claim 20, wherein the sequences of instructions that, when executed, cause the electronic system to transmit the located communication number to the presenting location prior to receiving the entire candidate communication number comprise sequences of instructions that, when executed, cause the electronic system to:
transmit one or more located communication numbers corresponding to the one or more digits of the candidate communication number from the database to the presenting location prior to receiving the entire candidate communication number; and
reduce the one or more located communication numbers, as the one or more located communication numbers fail to contain each subsequently received digit of the candidate communication number.

28. An apparatus comprising:
a communication number digits receiver to receive one or more digits of a candidate communication number;
a communication number searcher coupled with the communication number digits receiver to search a database for a communication number corresponding to the one or more digits of the candidate communication number; and
a communication number transmitter coupled with the communication number searcher to transmit to a presenting location one or more located communication numbers corresponding to the one or more digits of the candidate communication number prior to receiving an entire candidate communication number.

29. The apparatus of claim 28, wherein the communication number comprises a telephone number.

30. The method of claim 29, wherein the presenting location comprises a telephone.
